(19) United States
(12) Patent Application Publication
(10) Pub. No.: US 2020/0305469 A1
(43) Pub. Date: Oct. 1, 2020

(54) METHOD FOR PRODUCING A SUGAR-REDUCED FRUIT JUICE, IN PARTICULAR APPLE JUICE

(71) Applicant: "GRADIENT" PROCESS TECHNOLOGY GMBH, Wien (AT)

(72) Inventors: Patricia NOVALIN-CANOY, Wien (AT); Timon NOVALIN, Wien (AT)

(73) Assignee: "GRADIENT" PROCESS TECHNOLOGY GMBH, Wien (AT)

(21) Appl. No.: 16/765,581

(22) PCT Filed: Jun. 21, 2018
(86) PCT No.: PCT/AT2018/000059

§ 371 Date: May 20, 2020

(30) Foreign Application Priority Data
Nov. 30, 2017 (AT) GM 256/2017

(51) Int. Cl. A23L 2/04; A23L 2/72; A23N 7/02; A23N 1/00; A23L 33/20

(52) U.S. Cl. CPC A23L 2/04; A23L 2/72; A23L 33/20; A23N 1/00; A23N 7/02

(57) ABSTRACT

A method for producing a sugar-reduced fruit juice (S), in particular apple juice, wherein components of the fruit (A) are pressed after an at least partial comminution or fractioning process for obtaining the fruit juice. Prior to the pressing process using solely one part (16) of the fruit flesh; at least one part of the juice (14) obtained from the pressed fruit flesh is subjected to an at least partial sugar-removal method (S5); and the juice (15) obtained from the sugar-removal method is combined or mixed with the juice from the pressing process of the rind (11) and optionally the juice (17) from the remaining part of the fruit flesh, whereby the production of a sugar-reduced fruit juice (S) is made possible while retaining as much of the secondary plant contents as possible.

### FIELD OF THE INVENTION

The present invention relates to a method for producing a sugar-reduced apple juice, wherein components of the fruit are pressed, in particular after an at least partial comminution or fractionation, for obtaining the fruit juice, wherein at least a part of the juice obtained from the pressed fruit flesh is subjected to an at least partial sugar-removal process.

### PRIOR ART

An almost selective separation of sugars such as glucose, fructose or sucrose from fruit juices or similar liquid fruit mixtures such as smoothies is extremely difficult from a technological point of view and hardly feasible economically according to the current prior art. In this respect, it is frequently not required to almost completely separate the sugar. By contrast, a reduction of the sugar content by about one third to about one half will, for instance, do, wherein it is, in particular, requested to keep substantially unchanged further valuable ingredients such as flavors, aromas, polyphenols and acids or the like. To this end, chromatographic methods can, for instance, be applied, which are, however, not economically feasible for various reasons.

A method according the above-mentioned kind can, for example, be taken from U.S. Pat. No. 5,403,604 A, wherein for producing a sugar-reduced fruit juice a part of the juice obtained from the pressed fruit flesh is subjected to a sugar-removal method and thereafter a mixing with a fruit juice obtained from further fruit components takes place.

Moreover there has become known from US 2006/0105089 A1 a method for producing a citrus juice, aiming at the extraction of components of the skin or peel of such a citrus fruit.

Furthermore the applicant of the present invention conducted some tests to find out in how far the sugar content in fruits, e.g. apple fruits, is uniformly distributed, wherein it was shown that, as assumed, no uniform distribution of the sugar content exists in a fruit, in particular an apple. This assumption or finding was recently confirmed in the context of a scientific investigation (cf. “Importance of metabolite distribution in apple fruit. Anke Cebulj, Vlasta Cunja, Maja Mikulic-Petkovsek, Robert Veberic, Scientia Horticulturae, Vol. 214, Jan. 5, 2017, pp. 214-220”). It was shown there that, as is generally known, important secondary plant ingredients such as polyphenols, flavors etc. are, above all, contained to a major extent within the peels. Furthermore, it has been shown that the sugar content usually decreases from the region immediately below the peel towards the seeds or core, wherein differences in the amounts of sugar ranging from at least 15%, in particular at least 20% to 25%, are detectable. Furthermore, it has been shown that in the sugar-rich part in the region of the outer periphery or outer regions of the fruit flesh, directly below the skin or peel, more disaccharides or oligosaccharides, in particular sucrose, are present, while in the core region or central volume region of the fruit flesh the portion of monosaccharides, in particular in the form of glucose, is predominant such that, in the main, the distribution of different kinds of sugar is different.

### DESCRIPTION OF THE INVENTION

Taking into consideration the findings in respect to, in particular, the different distribution of sugar contents or sugar amounts in apple fruits, used for the production of a fruit juice or, in general, fruit drinks, the present invention, therefore, aims to provide an economically feasible and simple way to realize a reduction of sugar.

To solve these objects, a method of the initially defined kind is substantially characterized in that, prior to the pressing process, the skin of the fruit is removed by peeling and the skin is subjected to a separate pressing process, or a pressing process using only a part of the fruit flesh, that after the removal of the skin, an uppermost layer of the fruit flesh on the outer periphery or region of the fruit is separated from a core region of the fruit flesh, and these two parts of the separated fruit flesh are each subjected to a separate pressing process, and that the juice obtained from the sugar-removal process is combined or mixed with the juice from the pressing process of the skin and optionally with the juice from the remaining part of the fruit flesh. In that, according to the invention, the skin or peel of the fruit is removed by peeling prior to a pressing process, it is ensured that the secondary plant ingredients contained to a large degree in the skin, such as polyphenols, flavors etc., will be comprehensively retained in a fruit juice to be subsequently produced, so that by the sugar reduction sought according to the invention an impairment or, in particular, reduction of such secondary plant ingredients is avoided by previously peeling off the external skin. It is, moreover, provided that, in addition to removing the skin prior to the pressing process and subsequently pressing the skin, optionally with a part of the fruit flesh, a part of the juice obtained from a further part of the fruit flesh is separately subjected to a sugar reduction or sugar-removal process. After this, it is proposed according to the invention that the juice obtained from the pressing process of the skin, optionally with a part of the fruit flesh, is mixed or combined with the juice obtained from the sugar-removal process in order to provide an apple juice as a fruit juice that is reduced in its sugar content, on the one hand, yet, on the other hand, the secondary plant ingredients primarily contained particularly in the skin are completely contained in the fruit juice to be produced.

As pointed out above, it was found in the context of investigations that in the fruit flesh the sugar content in a fruit is not uniform in respect to both the sugar content and the kind of sugar. In this connection, it is furthermore proposed according to the invention, that, after the removal of the skin, an uppermost layer of the fruit flesh on the outer periphery or region of the fruit is separated from a core region of the fruit flesh, and these two parts of the separated fruit flesh are each subjected to a separate pressing process. The invention thus enables regions or parts of the fruit flesh with different sugar contents and at least partially different kinds or chemical textures of sugar to be partially separated from each other, wherein, according to the invention, a juice is produced from the separated parts of the fruit flesh each in a separate pressing process. For a particular simple separation of the several portions or parts of the fruit flesh it is preferably proposed that the separation of the uppermost layer of the fruit flesh on the outer periphery or region of the fruit is performed in the manner of a peeling process.

Alternatively to a separation process comparable in particular with a peeling process for subdividing the fruit flesh into an uppermost layer on the outer periphery and a fruit flesh in the core region, it is proposed according to a modified embodiment of the invention that, after the removal of the skin, a separation of the fruit flesh into a core region and a part located on the outer periphery is performed by removing, in particular punching out, the core region. In this manner, it is, for instance, possible, by using a device as is similarly used for removing a core, to perform a division into a part of the fruit flesh on the outer periphery or an uppermost layer of the fruit flesh and a part of the fruit flesh in the core region of the fruit, by dimensioning correspondingly larger the total core region of the fruit flesh to be removed, for instance by applying a cylindrical punching device. As in the preceding embodiment, it is thus possible, similarly to a peeling process, to separate regions or parts of the fruit flesh with different sugar contents and/or at least partially different kinds or chemical textures of sugar and subsequently subject them to a separate pressing processes and a sugar-removal process to be at least partially performed.

In order to obtain the desired sugar reduction, it is, moreover, proposed in the context of the method according to the invention that the part of the fruit flesh to be separated from the outer periphery of the fruit corresponds to between 15 and 50 vol. %, in particular 25 to 40 vol. %, of the total volume of the fruit flesh, as in correspondence with a further preferred embodiment of the method according to the invention. In this way, it is, in particular, possible by simple and reliable means within a subsequent sugar-removal process to eliminate a correspondingly high sugar amount from an overall product of the fruit juice to be produced.

In order to achieve an appropriate sugar reduction when treating only a part of the fruit juice to be obtained from the fruit flesh, it is proposed according to a further preferred embodiment that the juice obtained from the fruit flesh on the outer periphery of the fruit is subjected to a sugar-removal process by separation, in particular a nanofiltration and/or diafiltration. By applying a sugar-removal process by separation as proposed by the invention, of the juice obtained from the fruit flesh on the outer periphery of the fruit, in particular a nanofiltration, it has become possible in a simple and economically reliable as well as feasible manner to remove the oligosaccharides contained, in particular, in the fruit flesh on the outer periphery of the fruit, so that a correspondingly high portion of the substance with a high nutritional value can be removed. Considering the molecular size, which is larger in oligosaccharides than in monosaccharides, such comparatively simple separation or filtration methods thus allow for the reliable, selective removal of such oligosaccharides. A diafiltration can, for instance, be performed with a pre-pressed and partially desugared juice of the fruit flesh in order to avoid, in particular, an addition of water or other diluents. Furthermore, it is possible to perform a multi-stage nanofiltration process each with different pore sizes.

In particular in a process management according to the invention, by which the sugar content is appropriately reduced by separation from a juice obtained from the fruit flesh on the outer periphery of the fruit, it is proposed according to a further preferred embodiment that the skin is pressed together with the fruit flesh from the core region of the fruit in a common pressing process. In this manner, a possibly more elaborate, separate skin pressing process for obtaining, in particular, secondary plant ingredients can, in particular, be renounced and the skin can be pressed together with the fruit flesh from the core region of the fruit in a usual pressing process known per se.

Instead of dividing the fruit flesh into different parts or fractions, in particular a part from the outer periphery of the fruit flesh below the previously removed skin and a part of the core region thereof, a modified embodiment of the method according to the invention contemplates that a part of the juice obtained from a pressing process of the entire fruit flesh is subjected to a sugar-removal process by separation, in particular a nanofiltration and/or diafiltration. Even when jointly pressing the entire fruit flesh upon separation of the skin, it is possible in a simple separation and, in particular, nanofiltration process to ensure a simple and reliable separation of, in particular, oligosaccharides, which, again in a simple and reliable manner, enable an appropriate reduction of the sugar having a high or higher nutritional value.

In order to assist the pressing process and, in particular, obtain a correspondingly high yield of juice from the fruit flesh, or separated fruit flesh parts, to be pressed, it is proposed according to a further preferred embodiment that the fruit flesh, or the separated fruit flesh parts, is/are disintegrated prior to the pressing process.

Since the sugar-removing process, besides the removal of at least a portion of the sugar, may involve a slight loss in the juice amount to be produced, it is proposed according to a further preferred embodiment for compensating such a loss during the sugar-removal process that a volume loss of the juice caused by the sugar-removal process is compensated by adding liquid components, in particular water and/or conventionally pressed and desugared fruit juice. Such an addition of water for compensating part of the juice may not be required when carrying out a nanofiltration and/or diafiltration.

In order to achieve a correspondingly significant sugar reduction in the fruit juice or fruit drink to be produced, for instance of the order of 30 to 40%, it is additionally proposed, in particular when bearing in mind that according to the invention only a part of the juice to be obtained in total from the fruit flesh is subjected to a sugar reduction, that a reduction of the sugar content of the juice part to be filtered of at least 50%, in particular 75%, is effected by separation, in particular nanofiltration and/or diafiltration, as in correspondence with a further preferred embodiment of the method according to the invention.

In order to achieve the at least partial sugar reduction sought by the invention, it is proposed according to a further modified embodiment of the method according to the invention that only a part of a batch of a fruit to be processed is subjected to a sugar reduction after the removal of the skin and the remaining part of the batch, together with the part of the fruit flesh not subjected to a sugar reduction and/or the skin, is subjected to a common pressing process and subsequent combining and mixing with the juice obtained from the sugar-removal process. According to this process management, a subdivision of the batch of the fruit to be treated into a part that is subjected to a sugar reduction similarly to the above-described operations, in particular after the removal of the skin, while a remaining or residual part of the batch of the fruit according to the invention is subjected to a pressing process, or a treatment with the part of the fruit flesh not subjected to a sugar reduction and/or the skin, so that after the final combining and mixing according to the invention with the juice obtained from the sugar-removal process a sugar-reduced fruit juice is altogether obtained. Since a part of a batch of the fruit to be treated is subjected to a conventional method for producing a fruit juice rather than a more complex sugar-removal process, the expenditures for producing a sugar-reduced fruit juice can altogether be reduced accordingly.

According to a further modified process management of the invention for producing a sugar-reduced apple juice by adjusting the sugar content of the fruit juice, it is proposed to mix a sugar-reduced fruit juice produced according to the above-described method or a preferred embodiment thereof with a conventionally produced fruit juice without sugar reduction. Thus, a sugar-reduced fruit juice can again be provided, wherein, starting from a whole batch of fruit to be processed, only a part is subjected to the method according to the invention for providing a sugar-reduced fruit juice, while a remaining or residual part is processed or treated by a conventional, less complex method, so that, in the main, a sugar-reduced fruit juice can be provided at reduced production expenditures.

According to a further modified embodiment, it is proposed in this connection, for producing a sugar-reduced apple juice by adjusting the sugar content of the fruit juice, to perform a treatment of a portion or part of the batch of a fruit according to the above-described method or a preferred embodiment thereof for producing a sugar-reduced fruit juice and the subsequent mixing with a fruit juice obtained from the remaining batch without sugar reduction. In this manner, similar advantages as in the previously mentioned embodiment will be provided, in particular by reducing the expenditures for producing or providing a sugar-reduced fruit juice.

In order to achieve the intended sugar reduction, it is proposed in this context according to a further preferred embodiment that the part of the sugar-reduced fruit juice is selected to be at least 35 vol %, in particular at least 50 vol. %.

Overall, in particular under consideration of the fact or finding that a non-uniform distribution of the sugar and also different kinds of sugars are contained in a fruit, e.g. an apple fruit, a selective sugar reduction to an appropriately high degree has become possible at economically reasonable or acceptable expenditures and, in particular, without substantial impairment or reduction of the contents of secondary plant ingredients which are, for instance, primarily responsible for the taste, aroma etc. of such a fruit juice or fruit drink to be produced.

### DESCRIPTION OF THE DRAWINGS

The method according to the invention will be explained in more detail by way of exemplary embodiments schematically illustrated in the accompanying drawing.

FIG. 1 depicts a schematic flow chart of a first embodiment of the method according to the invention, in which, upon separation of the skin, a division of the fruit flesh into different parts is performed, which are each subjected to a separate pressing process;

FIG. 2 depicts a flow chart of a modified embodiment of the method according to the invention, wherein, as in the embodiment according to FIG. 1, a division of the fruit flesh into different parts is performed upon separation of the skin;

FIG. 3 depicts a flow chart of a further modified embodiment of the method according to the invention, wherein, for the production of the fruit juice, only the fruit flesh derived from the skin and the core region of the fruit, which has a lower sugar content, is used;

FIG. 4 depicts a flow chart of a further modified embodiment of the method according to the invention, wherein a part of the juice of the entire fruit flesh is subjected to a partial sugar reduction;

FIG. 5 depicts a flow chart of a further modified embodiment of the method according to the invention, which is similar to the process management according to FIG. 1, wherein a division of the fruit flesh into different parts is performed by a punching process for separating the core region of the fruit flesh; and

FIG. 6 depicts a flow chart of a further modified embodiment of the method according to the invention, illustrating the subdivision of a batch of a fruit to be treated into a part to be subjected to the method according to the invention, for instance similarly to the method according to FIG. 1, and a batch part subjected to a conventional processing process, for instance only by pressing.

### DETAILED DESCRIPTION OF THE INVENTION

In the following description, the individual parts of the fruits and the juice to be produced are each denoted by the reference numerals of arrows characterizing the respective parts or flows in the flow charts.

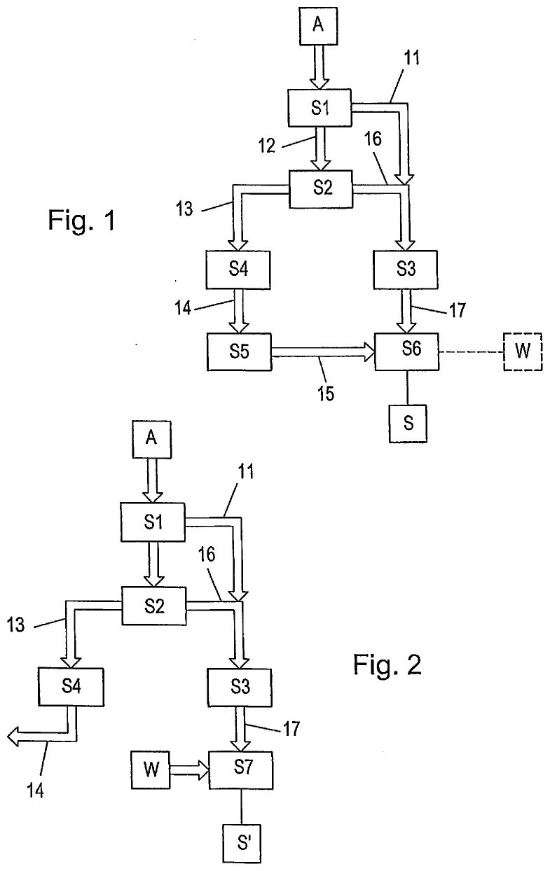

In the embodiment according to FIG. 1, apples A are provided as fruits for the production of a fruit juice comprised of an apple juice, wherein the skin peel or rind 11 is removed by a peeling process in a first method step S1 and discharged along the respective arrow.

The fruit flesh 12 discharged along the respective arrow from the peeling process according to step S1 in a subsequent step S2 is divided into two different parts or fractions, wherein a part 13 obtained from the outer periphery or region of the fruit flesh in a further peeling process is discharged from step S2 along the respective arrow.

Part 13 of the fruit flesh from the outer periphery of the entire fruit flesh in a step S4 is subjected to a pressing process of the fruit flesh part with higher sugar content from the outer periphery of the fruits. The juice 14 drained from step S4 is subsequently subjected to at least a partial separation of the sugar by a separation process, in particular nanofiltration, in step S5.

From the sugar-removal process of step S5, a fruit juice part 15 with reduced sugar content is obtained along the respective arrow.

In step S5, a reduction of, in particular, disaccharides and/or oligosaccharides to an extent of at least 60% is performed by the separation process, in particular nanofiltration and/or diafiltration.

In addition to the fruit flesh part 13 obtained in step S2 from the outer periphery of the entire fruit, a fruit flesh part 16 that is, in particular, derived from the core region of the fruit flesh is obtained and drained from step S2 along the respective arrow. Part 16 of the fruit flesh with a sugar content reduced relative to that of the part 13 in a step S3 is subjected to a separate pressing process together with the skin 11 removed in step S1.

The juice part 17 obtained in step S3 along the respective arrow in a step S6 is mixed with the sugar-reduced juice part 15 and optionally subjected to conventional further processing to finally yield a juice S with a correspondingly reduced sugar content.

To compensate for a slight loss of the juice of the partially sugar-reduced juice part 15, an addition of a liquid component, in particular water W or a partially desugared juice, can be effected as schematically indicated in FIG. 1 in broken lines.

When carrying out a nanofiltration in step S5, the addition of water to compensate a lacking juice part is not necessary.

When processing fruits for the production of a juice according to the method flow illustrated in FIG. 1, the following parameters can be applied, using an average variety of apple fruit with an average composition:

Apple mass: about 135 g

Sugar content: about 13.6%

Sugar content in the fruit flesh layer located on the outer periphery (below the skin and after the removal of the latter): about 20% higher than in the core region of the fruit flesh

Separation of the fruit flesh layer located on the outer periphery from the total of the fruit flesh mass: about 30 to 35 vol. %

Sugar reduction of the sugar-rich part 14 in step S5: 75 to 85 vol. %

Reduction of the sugar content of the total juice: about 30 to 35%.

An exemplary process management in the individual steps of FIG. 1 is as follows:

Apple mass about 10 kg, sugar content about 13.5% (sucrose content of the sugar about 25%)

Step S1: removal of the skins with a manual apple peeler (mass of skin fraction about 0.9 kg)

Step S2: peeling of the upper (sugar-rich) fruit flesh layer (mass of this fruit flesh fraction: about 3.1 kg)

Step S3: pressing of the fruit flesh fraction with lower sugar content together with the skin (after disintegration) by a basket press (juice yield about 4.9 kg)

Step S4: pressing of the fruit flesh fraction with higher sugar content by a basket press (juice yield about 2.2 kg)

Step S5: partial separation of the sugar from the fruit juice with higher sugar content by nanofiltration/diafiltration:

Nanofiltration (Process Parameters):

Polyamide-based membrane, pressure: 50 bar, temperature: about 25° C.

Nanofiltration result: permeate yield about 60% (1.35 kg+0.85 kg diafiltrate), concentrate mass about 0.85 kg

Step S6: mixing of the juice fractions from steps 3 (4.9 kg) and 5 (2.2 kg)

Result: sugar content in mixed juice about 7.2% (for comparison: sugar content in conventionally produced juice about 10.5%).

In the process management illustrated in FIG. 2, the same reference numerals are used for identical elements, a further detailed description being omitted.

Similarly as in the embodiment according to FIG. 1, apples A the skin 11 of which is removed in step S1 are provided for producing a fruit juice. In a subsequent step S2, a division of the fruit flesh into different parts is again performed, the part 13 of the fruit flesh on the outer periphery of the fruit flesh being subjected to a pressing process S4.

The juice part 14 obtained in this embodiment from the pressing process according to step S4 is supplied to a separate utilization in the embodiment according to FIG. 2.

The part 16 corresponding to the core region of the fruit flesh in step S3 is again pressed to juice together with the separated skin 11, wherein, in the embodiment according to FIG. 2, the juice 17 obtained from the pressing process according to step S3 is mixed and blended with water W or a partially desugared juice in a subsequent step S7. The portion of water W in this case is substantially chosen to replace the juice part 14 from the fruit flesh with a higher sugar content as obtained in step S4.

By the addition of water W, an appropriate sugar reduction of the total juice S′ to be produced is again achieved while maintaining the complete content of, in particular, secondary plant ingredients.

A sugar reduction of the order of 35 to 40% can also be achieved in the method according to FIG. 2.

An exemplary process management in the individual steps of FIG. 2 is as follows:

Apple mass about 10 kg, sugar content about 14% (sucrose content of the sugar about 25%)

Step S1: removal of the skins with a manual apple peeler (mass of skin fraction about 0.85 kg)

Step S2: peeling of the upper (sugar-rich) fruit flesh layer (mass of the fruit flesh fraction 14: about 3 kg)

Step S3: pressing of the fruit flesh fraction with a lower sugar content together with the skin (after disintegration) by a basket press (juice yield about 4.8 kg)

Step S7: mixing of the juice fraction from step S3 (4.8 kg) with 2.2 kg water

Result: Sugar content in mixed juice about 6.8% (for comparison: sugar content in conventionally produced juice about 10.5%).

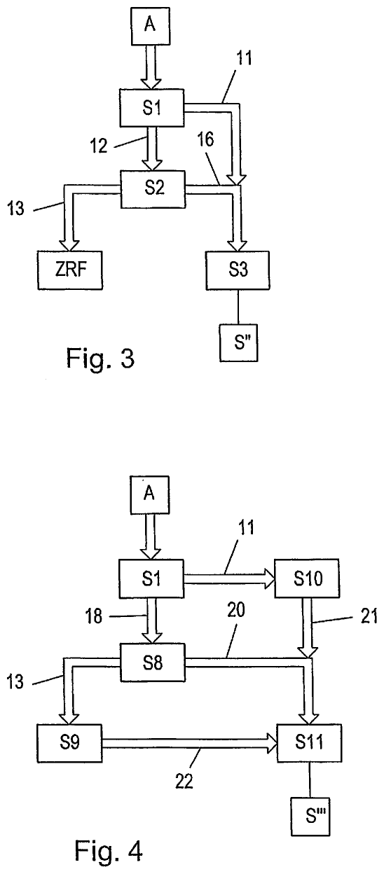

In the further modified embodiment according to FIG. 3, steps S1 and S2 are performed identically to those of the preceding embodiments according to FIGS. 1 and 2.

The fraction obtained in step S2 as part 13 with elevated sugar content is subjected to separate further processing as ZRF.

Similarly as in the preceding embodiments, the part 16 of the fruit flesh from the core region in step S3 is again pressed together with the skin 11 and obtained as juice S″.

As opposed to the preceding embodiments, a correspondingly reduced juice part containing all of the secondary plant ingredients is again obtained by the process management according to FIG. 3.

Due to the reduced sugar content of the part 13 from the core region of the fruit flesh, a sugar-reduced juice S″ in which the extent of sugar reduction is about 10 to 15% is altogether obtained.

An exemplary process management in the individual steps of FIG. 3 is as follows:

Apple mass about 10 kg, sugar content about 14% (sucrose content of the sugar about 25%)

Step S1: removal of the skins with a manual apple peeler (mass of skin fraction about 0.83 kg)

Step S2: peeling of the upper (sugar-rich) fruit flesh layer (mass of fruit flesh fraction 13: about 3.1 kg)

Step S3: pressing of the fruit flesh fraction with a lower sugar content together with the skin (after disintegration) by a basket press (juice yield about 4.8 kg)

Result: Sugar content in mixed juice about 9.4% (for comparison: sugar content in conventionally produced juice about 10.5%).

In the further modified embodiment according to FIG. 4, apples A are peeled in step S1, wherein subsequently the entire fruit flesh 18 is subjected to a pressing process in step S8 along the respective arrow.

From said pressing process S8, a part 19 of the entire juice is subjected to a sugar-removal process, wherein a sugar reduction of at least 60 to 65% is performed in step S9.

The skins 11 separated in step S1 are subjected to a separate pressing process according to step S10.

The juice part 21 obtained from the skins, together with the remaining juice part 20 from the pressing process according to step S8 of the entire fruit flesh, in step S11 is mixed with the sugar-content-reduced juice part 22 from the sugar-removal process according to step S9 and optionally subjected to conventional further processing.

From step S11, a sugar-reduced juice S′″ is taken, wherein, similarly as in the embodiments according to FIGS. 1 and 2, a sugar reduction of about 30 to 40% of the entire juice is again achievable while largely maintaining all of the secondary plant ingredients.

An exemplary process management in the individual steps of FIG. 4 is as follows:

Apple mass about 10 kg, sugar content about 14% (sucrose content of the sugar about 25%)

Step S1: removal of the skins with a manual apple peeler (mass of skin fraction about 0.84 kg)

Step S8: pressing of the entire fruit flesh by a basket press (after disintegration)

Step S10: pressing of the skin by a basket press (after disintegration)

Step S9: separation of the sugar from a fraction of the fruit flesh juice (juice amount about 2.5 kg) by evaporation of the solution and condensation (recovery) of the evaporated fraction.

Evaporation:

Vacuum evaporation at about 200 mbar (laboratory scale) Step S11: mixing of the condensate from step S9 with the two juice fractions from steps S8 and S10.

Result: Sugar content in mixed juice about 7.1% (for comparison: sugar content in conventionally produced juice about 10.5%).

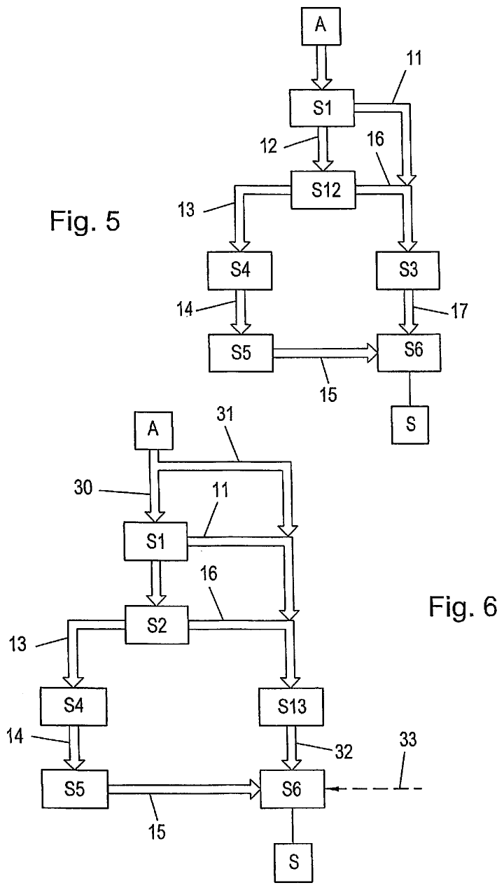

The process management embodiment illustrated in FIG. 5 only differs from the configuration according to FIG. 1 by the implementation of a step of dividing the fruit flesh into two different parts or fractions. While, in the configuration according to FIG. 1, in a step S2 a subdivision of the fruit flesh into parts on the outer periphery and in the core region similarly to a peeling process according to step S2 is performed, a separation of the fruit flesh again into a part on the outer periphery and a part in the core region is performed by a punching process in a step S12 in the embodiment according to FIG. 5. In doing so, a correspondingly larger core region containing a respective fruit flesh part with a lower sugar content is separated similarly as in the removal of a core region, wherein the parts 13 and 16 are subjected to different further processing steps S3 and S4 similarly as in the embodiment according to FIG. 1.

Since the further steps according to FIG. 5 correspond to the steps described with reference to FIG. 1, a further detailed description is is not necessary while the respective reference numerals are maintained.

Similarly, the exemplary embodiment indicated in FIG. 1 can also be applied or used in the process management according to FIG. 5.

In the further embodiment according to FIG. 6, after providing a batch of fruits or apples A, a subdivision of the batch into a part 30, which is subsequently subjected to a sugar-removal process, for instance in correspondence with the exemplary embodiment according to FIG. 1, and a batch part 31, which is subsequently directly subjected to the step S13 of a joint pressing process with the separated skin according to part 11 from step S1 and with the fruit flesh from the core region according to part 16.

The fruit flesh part 13 obtained in step S2 of FIG. 6 from the outer periphery of the whole fruit is subjected to a pressing process in step S4 similarly as in the embodiment according to FIG. 1 and to the production of a sugar-reduced juice part 15 in step S5.

By contrast, the skins according to part 11 and the fruit flesh part 16 from the core region in step S13 (which step corresponds to step S3 of FIG. 1) are subjected to a common pressing process together with the untreated part 31 of the batch for providing a juice part 32, which subsequently, in the step again denoted by S6, is subjected to mixing with the sugar-reduced juice according to juice part 15 for providing the juice S.

In order to achieve the desired sugar reduction, part 30 of the batch, which is subjected to the production of a sugar-reduced fruit juice, can be selected to account for at least 35 vol. %, in particular at least 50 vol. %.

The process parameters mentioned in connection with the exemplary embodiment according to FIG. 1, for producing the sugar-reduced juice part from part 30 of the batch can also be applied in the exemplary embodiment according to FIG. 6.

Instead of processing the part 31 not to be subjected to a sugar reduction, of the batch of the fruit A to be treated, it may be provided in a common pressing process according to step S13 that the sugar-reduced juice obtained from part 30 of the batch in step S6 is mixed with a conventionally produced juice obtained, for instance, from part 31 of the batch along arrow 33 for providing the juice S.

Instead of using apples for the production of a sugar-reduced apple juice, also other, in particular, peelable fruits such as pears, apricots etc., which have similar sugar contents in different regions of the fruit flesh can be used.

With further peelable fruits such as mangos, kiwis, oranges etc., in which the skin is not used for the production of a fruit juice, a division into individual fractions of the fruit flesh with different sugar contents and a separate treatment of the juice of such individual fractions can likewise be performed for obtaining a sugar-reduced fruit juice with all fruit ingredients.

1-14. (canceled)

15. A method for producing a sugar-reduced apple juice, wherein components of the fruit are pressed, after an at least partial comminution or fractionation, for obtaining the juice, wherein at least a part of the juice obtained from pressed fruit flesh is subjected to an at least particle sugar-removal process, wherein, prior to the pressing process; removing the skin of the fruit by peeling; subjecting the skin to a separate pressing process, or a pressing process using only a part of the fruit flesh; after the removal of the skin, separating an uppermost layer of the fruit flesh on the outer periphery of the fruit from a core region of the fruit flesh; subjecting these two part of the separated fruit flesh to a separate pressing process; and; combing or mixing the juice obtained from the sugar-removal process with the juice from the remaining part of the fruit flesh.

16. The method according to claim 15, wherein the separation of the uppermost layer of the fruit flesh on the outer periphery of the fruit is performed by a peeling process.

17. The method according to claim 15, wherein, after the removal of the skin and the separation of the fruit flesh into the core region and the uppermost layer of the fruit flesh located on the outer periphery, the core region is removed by punching it out.

18. The method according to claim 15, wherein the part of the fruit flesh to be separated from the outer periphery of the fruit corresponds to between 15 and 50 vol %, of the total volume of the fruit flesh.

19. The method according to claim 15, wherein the juice obtained from the fruit flesh on the outer periphery of the fruit it subjected to a sugar-removal process by separation.

20. The method according to claim 15, wherein the skin is pressed together with the fruit flesh from the core region of the fruit in a common pressing process.

21. The method according to claim 15, wherein a part of the juice obtained from a pressing process of the entire fruit flesh is subjected to a sugar-removal process by separation.

22. The method according to claim 15, wherein the fruit flesh, or the separated fruit flesh parts, is/are disintegrated prior to the pressing process.

23. The method according to claim 15, wherein a volume loss of the juice caused by the sugar-removal process is compensated by adding liquid components, and/or conventionally pressed and desugared fruit juice.

24. The method according to claim 15, wherein a reduction of the sugar content of the juice part to be filtered of at least 50%, is effected by separation.

25. The method according to claim 15, wherein only a part of a batch of a fruit to be processed is subjected to a sugar reduction after the removal of the skin and the remaining part of the batch, together with the part of the fruit flesh not subjected to a sugar reduction and/or the skin, is subjected to a common pressing process and subsequent combining and mixing with the juice obtained from the sugar-removal process.

26. The method for producing a sugar-reduced apple juice, by adjusting the sugar content of the fruit juice, comprising mixing a sugar-reduced fruit juice produced according to the method according to claim 1 with a conventionally produced fruit juice without sugar reduction.

27. The method for producing a sugar-reduced apple juice, by adjusting the sugar content of the fruit juice, comprising treating a part of a batch of the fruit according to the method according to claim 1 for producing a sugar-reduced fruit juice and mixing with a fruit juice obtained from the remaining batch of the fruit without sugar reduction.

28. The method according to claim 26 wherein the part of the sugar-reduced fruit juice is chosen to be at least 35 vol %.
